(19) United States
(12) Patent Application Publication
(10) Pub. No.: US 2014/0180897 A1
(43) Pub. Date: Jun. 26, 2014

(54) SYSTEMS AND METHODS FOR MULTI-CURRENCY TRADING

(71) Applicant: CUREX INNOVATIONS LLC, New York, NY (US)

(72) Inventors: William JP Dale, New York, NY (US); Dmitry A. Raykhman, Brooklyn, NY (US)

(21) Appl. No.: 14/150,561

(22) Filed: Jan. 8, 2014

Related U.S. Application Data
(63) Continuation-in-part of application No. 13/540,072, filed on Jul. 2, 2012.
(60) Provisional application No. 61/504,503, filed on Jul. 5, 2011.

(51) Int. Cl. G06Q 40/04

(52) U.S. Cl. CPC G06Q 40/04
USPC 705/37

(57) ABSTRACT

A multi-currency interface: programmed or configured for limit orders in a customer currency for financial instruments traded in an exchange traded currency. A multi-currency interface programmed or configured for facilitating purchases of goods or services from an online merchant in multiple currencies.

### CROSS-REFERENCE TO RELATED APPLICATION

This application is a continuation-in-part of U.S. patent application Ser. No. 13/540,072, filed Jul. 2, 2012, which claims the benefit of Provisional Application No. 61/504,503, filed Jul. 5, 2011, the entire contents of which are incorporated herein by reference.

### FIELD OF THE INVENTION

The present invention relates to computer-implemented methods and systems for offering and trading financial instruments. More specifically, the present invention relates to computer-based and computer-implemented systems and methods for offering and trading financial instruments in multiple currencies.

### BACKGROUND

The currency market represents one of the world's largest financial markets. One reason investors purchase foreign currencies is to manage foreign exchange risk exposure. For example, United States residents going to visit a European country on vacation have the risk that if that if the Euro (EUR) appreciates against the United States Dollar (USD), their vacation will be more expensive. Exporters who sell products in foreign currency have the risk that if the value of that foreign currency falls, then the revenues in the exporter's home currency will be lower. An importer who buys goods priced in foreign currency has the risk that the foreign currency will appreciate and make the local currency cost greater than expected.

Fund managers and companies who own foreign assets are also regularly exposed to changes in currency exchange rates. For example, a mutual fund manager who purchases foreign securities in a foreign currency for a mutual fund that is traded in a home currency must take into account fluctuations in currency exchange rates in managing the assets of the mutual fund. A large number of investors also invest in foreign currencies for speculative purposes, i.e., to profit from accurately predicting changes in currency rates.

In every foreign exchange transaction, one currency is purchased and another currency is sold. The currencies that are purchased and sold in a foreign exchange transaction are also referred to as a currency pair. A currency pair consists of a base currency and a reference currency. EUR/USD is an example of a currency pair. In this example, the base currency is EUR and its value remains constant at one EUR. The reference currency is USD. The value of the reference currency fluctuates up and down relative to the base currency. For example, if the EUR/USD currency pair is quoted at 1.1500, it means that one EUR costs USD 1.1500. Likewise, if the EUR/USD currency pair increases to 1.2000, the same EUR is now equivalent to USD 1.2000.

Currency transactions can be quoted in one of two ways: American-terms, in which a currency is quoted in terms of the number of United States Dollar per unit of foreign currency (e.g., how many USD to buy 1 EUR), and in European-terms, in which one United States Dollar is quoted in terms of number of units of foreign currency per dollar (e.g., how many Euro to buy 1 USD). The same logic can be applied to currency pairs in which the USD is not one of the currencies. Either currency can be expressed in terms of the other. However there are generally accepted conventions in the inter-bank foreign exchange marketplace that have been adopted by most of the foreign exchange marketplace. For example, the EUR/USD pair is quoted in American Terms and the Swiss Franc is quoted in European Terms.

In currency trading, a long position refers to entering into a contract to buy a base currency in exchange for a set amount of reference currency at a set time in the future. A trader may speculate that the price of a base currency will increase relative to the value of the reference currency by entering into a long position. A short position in currency trading means that the trader has entered into a contract to sell a set amount of base currency in exchange for a set amount of reference currency. A trader may speculate that the price of a base currency will decrease relative to the value of the reference currency by entering into a short position.

Foreign exchange (FX) transactions are offered as FX spot transactions or FX forward transactions. FX spot transactions are exchanges of one currency for another for immediate delivery. FX spot transactions are conducted at an exchange rate for immediate delivery known as the spot rate. Immediate delivery in the spot market is generally two business days, which is called the value date. The two day settlement period is necessary to allow for trade processing and for currency payments to be wired around the world.

FX forward transactions are exchanges of one currency for another at a future date. FX forward transactions are conducted at a forward rate, which is the exchange rate available at the time of the purchase of the FX forward transaction for exchanging currency at some specified date in the future. The forward rate is a function of both the spot rate and the difference in interest rates that could be earned in money markets or bond markets in the respective two countries. The difference between a forward exchange rate and a spot exchange rate represents the benefit or disadvantage an investor would experience should they convert in the spot market from one currency represented in the pair to the other and hold the new currency earning interest at a risk free rate. To the extent that there is an economic advantage associated with a higher interest rate in the new currency, such advantage is reflected in the price of the FX forward transaction. The discount or premium to the spot price in an FX forward transaction of the same pair is typically referred to as the “carry” or “cost of carry.”

The foreign exchange market operates five days per week on a 24-hour trade date basis beginning at 5 p.m. Eastern Standard Time (EST) Sunday. A trading day begins at 5 p.m. EST and ending the next day at 5 p.m. EST. For example, on a Monday, spot currencies are trading for value on Wednesday (assuming no holidays). At 5 p.m. EST on Monday, the trade date becomes Tuesday and the value date becomes Thursday. A position opened on Monday at 5 p.m. EST is either closed or rolled over to the next value date before the end of trading day on Tuesday. In this example, a one-day rollover involves the open position being rolled over from a value date of Wednesday to that of Thursday.

Rollover transactions are effectuated by making two offsetting trades that result in the same open position. However, when making rollover transactions, the rate at which a currency pair is quoted can change. These changes represent the difference in interest rates between the two currencies in the trader's open position applied in currency-rate terms (i.e., one day of “carry” or “cost of carry”). They constitute net interest earned or paid by the trader, depending on the direction of the trader's position. Assuming there is no change in the spot exchange rate for the currency pair, a trader can earn money in a rollover transaction if the trader holds a long position in the currency with the higher interest rate and holds a short position in the currency with the lower interest rate. Conversely, a trader can lose money in a rollover transaction if the trader holds a short position in the currency with the higher interest rate and holds a long position in the currency with the lower interest rate.

Exchange traded funds (ETFs) offer public investors an undivided interest in a pool of securities or other assets and thus are similar in many ways to traditional mutual funds, except that shares in an ETF can be bought and sold throughout the day like stocks on a securities exchange through a broker-dealer. Unlike traditional mutual funds, traders and investors participating in a secondary market can buy and sell ETFs without having to redeem their individual shares at net asset value, or NAV. Instead, financial institutions or other qualified investors purchase and redeem ETF shares directly from the ETF in the primary market, but only in large blocks. In the case of currency ETFs, financial institutions or other qualified investors convert currency holdings to shares that trade in a publicly tradeable marketplace. It is recognized these have been developed and are substantially different from embodiments the present invention.

In 2005, Rydex Investments launched the first ever currency ETF called the Euro Currency Trust (NYSE: FXE) in New York. Since then Rydex has launched a series of funds tracking all major currencies under their brand CurrencyShares. In 2008, Deutsche Bank's db x-trackers launched Sterling Money Market ETF (LSE: XGBP) and US Dollar Money Market ETF (LSE: XUSD) in London.

Currency ETFs do not require rollover transactions to maintain currency positions, but they have disadvantages inherent in their structure. Currency ETF shares are priced to the foreign exchange rate plus interest, which creates tracking error from the currency price being traded. They also do not trade on the 24 hour per day trading cycle of the foreign exchange markets and are therefore more difficult to redeem. They also are quoted in a convention not consistent with the interbank market and with settlement periods not consistent with the foreign exchange interbank market. For this reason, they may have a value that may track the value of currency but cannot be considered fungible with spot FX contracts or forward contracts. Their lack of fungibility means they suffer from far less volume, less institutional participation in trading and price discovery and have greater risk of price tracking error Inherently, Currency ETFs are not an efficient vehicle to trade currencies or baskets of currencies as a security.

Currency ETFs also have disadvantages in the way that interest is paid. With currency ETFs, interest is earned in a reference currency and then converted into the base currency at some unknown rate close in time to the date on which dividends are paid (typically monthly) and then distributed to shareholders, which exposes currency ETF investors to additional foreign currency exposure on accrued interest.

There are also currency Exchange Traded Notes (ETNs) that have been developed. ETNs are debt securities backed by an issuer that are designed to provide investors access to returns of various benchmarks. Though linked to the performance of a market benchmark, ETNs are not equities or index funds, but they do share several characteristics of the latter. Similar to equities, they are traded on an exchange and can be shorted. Similar to index fund, they are linked to the return of a benchmark index. But as debt securities, ETNs do not actually own anything they are tracking.

There are currency ETNs that have been developed to attempt to provide investors with returns of certain currency benchmarks. But currency ETNs are subject to risk of default by the issuing bank as counter party. Currency ETNs also share many of the same disadvantages of currency ETFs, including that currency ETNs have disadvantages in the way that interest is paid and the way it is included in the price of the instrument making it more difficult for the trader to determine the accuracy of the instruments' tracking of the value of underlying assets, they are more difficult to redeem (they can be redeemed only in the primary market), and are not fungible with FX spot and forward transactions. This is due to the fact that an ETN is redeemable in the primary market for an amount equal to an index—making the ETN very accurate at tracking the index but this index may temporarily diverge in value from the underlying asset it seeks to track thus marking it more difficult to arbitrage price to the actual underlying asset. To effect such a price arbitrage, the trader would have to add an extra step of arbitraging the price of the index to the underlying assets it seeks to track thus adding complexity and cost to the process.

The global FX marketplace is estimated to transact over four trillion USD per day. Much of that volume is concentrated on a few pairs such as the EUR, USD and Japanese Yen. Rather than one centralized regulated marketplace, the global FX market consists of many fragmented, unregulated, over-the-counter pools of liquidity which can range from a single counterparty-to-counterparty market to a pool of liquidity providers competing for order flow from liquidity takers in an electronic order matching electronic network. The nature of the fragmentation of the global FX marketplace means it is possible that a single currency pair can trade at different prices, in different markets at the same time. It is desirable for the purpose of price transparency, liquidity and market confidence to provide methods and systems to attract traders for purpose of transparent price discovery and to add liquidity to the global FX marketplace, especially in currency pairs that do not enjoy the liquidity that exists in major currency pairs such as that of the US Dollar, Euro and Japanese Yen.

In the foreign exchange market, there are many liquidity pools each comprising an electronic communications network (ECN) operated based on credit and trading relationships. These pools may be created and sponsored by liquidity providers, for example, market makers that are sizable holders of positions in particular currencies that facilitate the trading of those currencies to investors seeking to transact in currencies, who are liquidity consumers.

Many exchanges operate as a single currency environment, where all securities trade on the exchange under such an environment are quoted and cleared in a single currency. This traditional approach severely limits the number of instruments available for trading on an exchange. Also, it forces customers to trade instruments in currencies they are not necessarily comfortable with converting profits and losses into the currency of customer choice after trades are done. In such single currency clearer environments customers have to perform currency conversion separately, and bear the currency conversion risks. This adds to uncertainty to the final price of securities bought or sold, and usually requires that a different account be opened to execute currency conversion trades. Moreover, the security trade and currency conversion trades cannot be executed simultaneously and different clearing cycle durations (typically 3 days for equity trading and 2 days for currency trading) add to the uncertainty and lack of transparency and complicate the settlement process.

Thus, there exists a need for a system that provides for trading in a number of different currencies without the disadvantages discussed above.

### SUMMARY

In accordance with a first aspect of the present invention, a computerized method is provided for trading financial instruments in multiple currencies in a trading environment having (a) a computerized trading exchange system that trades securities denominated in an exchange traded currency, (b) an FX trading platform, and (c) a multi-currency interface in communication with both the trading exchange and the FX trading platform. The method comprises: presenting, by a multi-currency interface, to at least one customer wishing to trade in a customer currency, a view of orders currently residing on the trading exchange, the view being presented in the customer currency; receiving, at the multi-currency interface, an order, including at least a price, from the at least one customer, the received order being denominated in the customer currency; if the customer currency is the same as the exchange quoted currency, submitting the order to the trading exchange for publication on the trading exchange; and if the customer currency is not the same as the exchange quoted currency, executing the following steps: performing, at the multi-currency interface, a calculation of a conversion rate from the customer currency to the exchange traded currency, the calculation being performed based upon FX index prices published by the FX trading platform; generating, at the multi-currency interface, an exchange order, denominated in the exchange quoted currency, corresponding the to the received order from the customer; and submitting the generated exchange order to the trading exchange for publication on the trading exchange.

In another aspect, the customer can select one or more customer currencies.

In another aspect, the presenting step comprises: for each order resting on the trading exchange, performing the following steps: (a) determining whether the customer currency is the same as the exchange traded currency, and if so, displaying the order to the customer without conversion; (b) if the customer currency is different from the exchange quoted currency, converting the order to the customer currency for display to the customer by: (i) performing, at the multi-currency interface, a calculation of a conversion rate from the exchange traded currency to the customer currency, the calculation being performed based upon FX index prices published by the FX trading platform, and (ii) executing a trade on the FX trading platform to generate an order in the customer currency that corresponds with the exchange order; and (c) displaying the generated order to the customer in the customer currency.

In another aspect, the generating step comprises: if the exchange quoted currency/customer currency pair is a pair quoted directly on the FX trading platform, using the calculated conversion price to buy, on the FX trading platform, exchange quoted currency v. customer currency (long exchange quoted currency/short customer currency), and generating the exchange order; and if the exchange quoted currency/customer currency pair is not a pair quoted directly on the FX trading platform, creating a synthetic price by buying exchange quoted currency against a major currency quoted directly on the FX trading platform, and selling customer currency against the same major currency to generate the exchange order.

In another aspect, the at least one customer comprises a plurality of buyers, each having a buyer's currency, and sellers, each having a seller's currency, and, after a match between orders of a respective buyer and seller on the exchange results in a trade between the buyer and the seller, the method further comprises: the multi-currency processor: receiving trade confirmations to the buyer and the seller; determining what FX transactions are needed to facilitate the multi-currency transaction and clearing process, and submitting, on behalf of the buyer and the seller, FX spot trades based on the determination.

In another aspect, (a) the trading environment further includes a central clearer that functions to clear all transactions executed on the trading exchange, and all transactions cleared in the central clearer are cleared in a clearing currency, and (b) the determining and submitting step determines the transactions that are needed based on the exchange quoted currency, the buyer's currency, the seller's currency and the clearing currency.

In another aspect, the order from the at least one customer is received from a member of the trading exchange, on behalf of the customer.

In another aspect, the member of the trading exchange also has an account with the FX trading platform.

In another aspect, the at least one customer comprises a buyer and a seller and the buyer and the seller communicate with the multi-currency interface using a buyer client and a seller client, respectively.

In accordance with a second aspect of the present invention, there is provided a multi-currency interface for facilitating trading of financial instruments in multiple currencies in a trading environment having a computerized trading exchange system that trades securities denominated in an exchange traded currency, and an FX trading platform, the multi-currency interface being in communication with both the trading exchange and the FX trading platform. The multi-currency interface has one or more server computers configured and programmed to: present, to at least one customer wishing to trade in a customer currency, a view of orders currently residing on the trading exchange, the view being presented in the customer currency; receive an order, including at least a price, from the at least one customer, the received order being denominated in the customer currency; if the customer currency is the same as the exchange quoted currency, submit the order to the trading exchange for publication on the trading exchange; and if the customer currency is not the same as the exchange quoted currency, execute the following steps: perform a calculation of a conversion rate from the customer currency to the exchange traded currency, the calculation being performed based upon FX index prices published by the FX trading platform, and generate an exchange order, denominated in the exchange quoted currency, corresponding the to the received order from the customer; and submit the generated exchange order to the trading exchange for publication on the trading exchange.

In another aspect, the customer can select one or more customer currencies.

In another aspect, to present to at least one customer wishing to trade in the customer currency, the view of orders currently residing on the trading exchange, the server computers of the multi-currency interface are further configured and programmed to: for each order resting on the trading exchange, perform the following steps: (a) determining whether the customer currency is the same as the exchange traded currency, and if so, displaying the order to the customer without conversion; (b) if the customer currency is different from the exchange quoted currency, converting the order to the customer currency for display to the customer by: (i) performing, at the multi-currency interface, a calculation of a conversion rate from the exchange traded currency to the customer currency, the calculation being performed based upon FX index prices published by the FX trading platform, and (ii) executing a trade on the FX trading platform to generate an order in the customer currency that corresponds with the exchange order; and (c) displaying the generated order to the customer in the customer currency.

In another aspect, to generate the exchange order the server computers of the multi-currency interface are further configured and programmed to: if the exchange quoted currency/customer currency pair is a pair quoted directly on the FX trading platform, use the calculated conversion price to buy, on the FX trading platform, exchange quoted currency v. customer currency (long exchange quoted currency/short customer currency), and generate the exchange order; and if the exchange quoted currency/customer currency pair is not a pair quoted directly on the FX trading platform, create a synthetic price by buying exchange quoted currency against a major currency quoted directly on the FX trading platform, and selling customer currency against the same major currency to generate the exchange order.

In another aspect, the at least one customer comprises a plurality of buyers, each having a buyer's currency, and sellers, each having a seller's currency, and, after a match between orders of a respective buyer and seller on the exchange results in a trade between the buyer and the seller, the multi-currency processor: receives trade confirmations to the buyer and the seller; and determines what FX transactions are needed to facilitate the multi-currency transaction and clearing process, and submits, on behalf of the buyer and the seller, FX spot trades based on the determination.

In another aspect, (a) the trading environment further includes a central clearer that functions to clear all transactions executed on the trading exchange, and all transactions cleared in the central clearer are cleared in a clearing currency, and (b) the determining and submitting determines the transactions that are needed based on the exchange quoted currency, the buyer's currency, the seller's currency and the clearing currency.

In another aspect, the order from the at least one customer is received from a member of the trading exchange, on behalf of the customer.

In another aspect, the member of the trading exchange also has an account with the FX trading platform.

In another aspect, the at least one customer comprises a buyer and a seller and the buyer and the seller communicate with the multi-currency interface using a buyer client and a seller client, respectively.

In another aspect, a computerized method for trading financial instruments in multiple currencies is provided, comprising: receiving a limit order from at least one customer for a financial instrument, including a price and a quantity denominated in a customer currency, at a multi-currency interface comprising one or more server computers executing on one or more processors in communication with (a) a computerized trading exchange system that trades the financial instrument denominated in an exchange quoted currency and (b) a foreign exchange (“FX”) trading platform electronically monitoring available liquidity on the computerized trading exchange and the FX trading platform at the multi-currency interface; when a new price is published on the computerized trading exchange in the exchange quoted currency for the financial instrument, automatically requesting available prices on the FX trading platform; receiving the available prices on the FX trading platform at the multicurrency interface; calculating at the multi-currency interface a price in the exchange quoted currency for converting the limit order in the customer currency to the exchange quoted currency based upon real time spot tradable index prices published by the FX trading platform; determining whether the conversion price is still available on the FX trading platform; and converting the limit order in the customer currency to the exchange quoted currency based on real time spot tradable index prices published by the FX trading platform

In another aspect, the multi-currency interface for facilitating trading of financial instruments in multiple currencies comprises: one or more server computers executing on one or more processors, the multi-currency interface in communication with (a) a computerized trading exchange system that trades securities denominated in an exchange quoted currency and (b) a foreign exchange (“FX”) trading platform, the multi-currency configured and programmed to:

receive a limit order from at least one customer for a financial instrument, including a price and a quantity denominated in a customer currency, at a multi-currency interface comprising one or more server computers executing on one or more processors in communication with (a) a computerized trading exchange system that trades the financial instrument denominated in an exchange quoted currency and (b) a foreign exchange (“FX”) trading platform; electronically monitor available liquidity on the computerized trading exchange and the FX trading platform at the multi-currency interface; when a new price is published on the computerized trading exchange in the exchange quoted currency for the financial instrument, automatically request available prices on the FX trading platform; receive the available prices on the FX trading platform at the multicurrency interface; calculating at the multi-currency interface a price in the exchange quoted currency for converting the limit order in the customer currency to the exchange quoted currency based upon real time spot tradable index prices published by the FX trading platform; determine whether the conversion price is still available on the FX trading platform; and convert the limit order in the customer currency to the exchange quoted currency based on real time spot tradable index prices published by the FX trading platform.

In yet another aspect, a computerized method for facilitating transactions of goods and services in multiple currencies is provided, the method comprising:

determining, by a multi-currency interface comprising one or more server computers executing on one or more processors in communication with (a) a computerized online merchant system that offers goods and services denominated in an online merchant system currency and (b) a foreign exchange (“FX”) trading platform, to present to at least one customer wishing to purchase the goods or services in a customer currency, a view of goods or services offered for sale currently residing on the online merchant system, the view being presented in the customer currency; receiving, at the multi-currency interface, an order for the goods or services offered for sale on the computerized online merchant system, including at least a price and a quantity, from the at least one customer, the received order being denominated in the customer currency; if the customer currency is the same as the online merchant system currency, submitting the order to the online merchant system for execution; and if the customer currency is not the same as the online merchant quoted currency, executing the following steps: performing, at the multi-currency interface, a calculation of a conversion rate of the price of the received order from the customer currency to the exchange traded quoted currency, the calculation being performed based upon real time spot tradable FX index prices published by the FX trading platform; generating an FX spot trade order on the FX trading platform at the conversion rate to generating, at the multi-currency interface, an order for the goods or services, denominated in the online merchant system quoted currency, corresponding to the received order from the customer; and submitting the generated goods or services order to the online merchant system for purchase of the goods or services in the customer currency.

In another aspect, A multi-currency interface for facilitating trading of goods and services in multiple currencies is provided comprising:

one or more server computers executing on one or more processors, the multi-currency interface in communication with (a) an online merchant system that trades goods and services denominated in an online merchant system quoted currency and (b) a foreign exchange (“FX”) trading platform, the multi-currency interface being in communication with both the trading exchange and the FX trading platform, the multi-currency interface having one or more server computers configured and programmed to:
present, to at least one customer wishing to trade in a customer currency, a view of orders of goods or services currently available for purchase on the online merchant system, the view being presented in the customer currency;
receive an order for the goods or services, including at least a price, from the at least one customer, the received order being denominated in the customer currency;
if the customer currency is the same as the online merchant quoted currency, submit the order to the trading exchange for publication on the trading exchange; and
if the customer currency is not the same as the online merchant quoted currency, execute the following steps: perform a calculation of a conversion rate of the price of the received securities order from the customer currency to the online merchant quoted currency, the calculation being performed based upon real time spot tradable FX index prices published by the FX trading platform,
generate an FX spot trade order on the FX trading platform at the conversion rate to generate an order in the customer currency that corresponds with the received order; generate an order for the goods or services, denominated in the online merchant quoted currency, corresponding the to the received order from the customer; and submit the generated goods or services order to the online merchant system for purchasing the goods or services.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### BRIEF DESCRIPTION OF THE DRAWINGS

FIG. 1 is a block diagram illustrating the environment in which a method according to one embodiment is carried out.

FIGS. 2 to 6 are diagrams illustrating exemplary trading scenarios that can be handled using the techniques of the present invention.

FIG. 7 is a flowchart showing the process for facilitating the submission of orders on the trading exchange in accordance with an aspect of the present invention.

FIG. 8 is a flowchart showing the process for presenting orders residing on the trading exchange to customers in accordance with an aspect of the present invention.

FIG. 9 is a block diagram illustrating the environment in which a method according to another embodiment directed to online merchant system payments is carried out.

### DETAILED DESCRIPTION

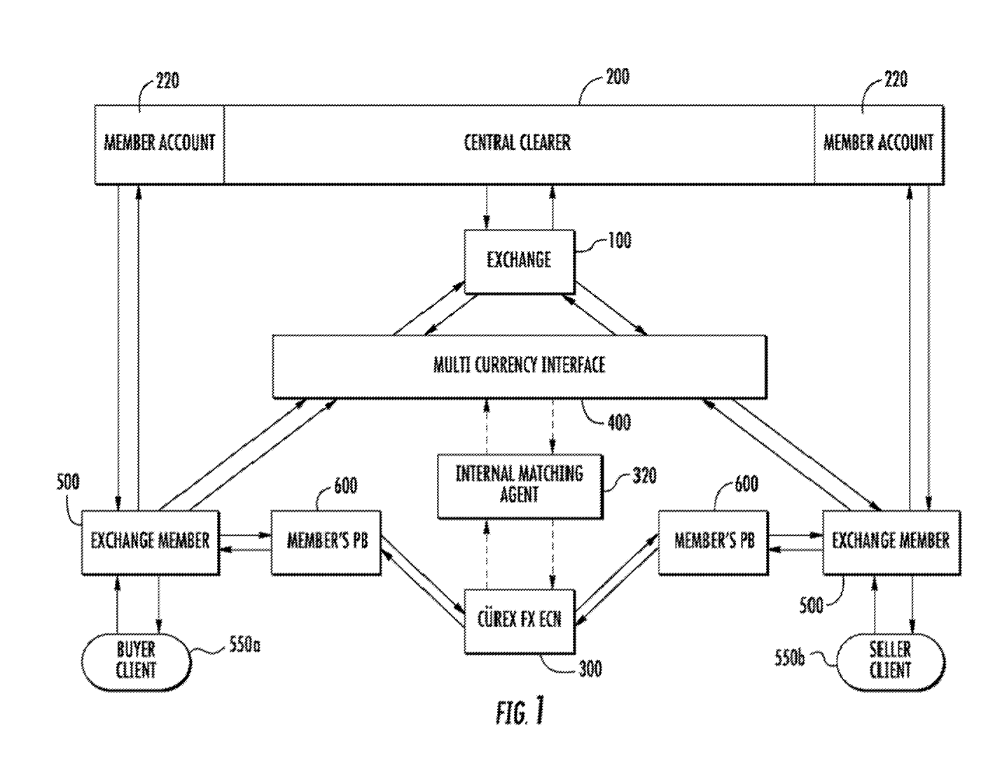

FIG. 1 is a diagram illustrating the entities involved in a multi-currency trade in accordance with the present invention. Exchange 100 is a regulated trading facility where securities are traded. Examples of exchanges include NYSE or NASDAQ. The type of currency used as a monetary unit in the exchange 100 to represent the value of each security offered on the exchange 100 is referred to as the “exchange quoted currency.” For example, the exchange quoted currency on the NYSE exchange is USD, and the exchange quoted currency on the NASDAQ exchange is USD.

A central clearer 200 is an entity that functions as a clearing facility responsible for centrally clearing all transactions executed on the exchange 100. The central clearer 200 is typically a single currency clearing environment, that is, the trading environment supported by the central clearer 200 is one in which all securities are quoted in a single currency denomination, and all transactions are cleared in that same currency. In this regard, a “clearing currency” is a currency that the central clearer could accept and tender as payment for security as part of the clearing process. The exchange 100 and the central clearer 200 each have servers that are configured and programmed to electronically communicate with one other. The term “security” as used herein refers to any instrument available for trading on an exchange, including equity, fixed income, commodities, currencies, and derivatives of said categories of securities. For example, DTCC clears all trades executed on NYSE and DTCC operates only in USD.

FX electronic communications network (ECN) 300 is an open and transparent online trading environment with transparent pricing and disclosed trading rules. The FX ECN 300 provides a liquidity pool where tradable prices and/or trade executions are used to publish real time FX index prices, as a liquidity index. The liquidity index provides FX ECN index prices, which are spot FX tradable prices generated from the FX ECN 300.

A multi-currency interface (MCI) 400 comprises a module that is in electronic communication with both the FX ECN 300 and the exchange 100. The MCI 400 is configured and programmed to provide currency prices in real time needed to show securities quoted in any currency and provide a gateway for submitting trades into the FX ECN 300 needed to convert amounts from one currency into another, as will be described in more detail below.

An internal matching agent (IMA) 320, preferably residing in the FX ECN 300, is configured and programmed to, whenever possible, internally match transactions submitted into FX ECN 300 by the MCI 400 to match buyers and sellers of securities at a mid-point price between bid and offer on FX ECN 300 for a given currency pair to minimize cost of the currency conversion component needed to facilitate the multi-currency security trading in accordance with the present invention.

Exchange members 500 are entities that have a seat on the exchange 100. Exchange members have a prime brokerage account with one or more of prime brokerage banks 600. A buyer client 550a is a client computer or module/interface used by a buyer in a currency trade. The buyer client 550a is in communication with an exchange member 500, and facilitates submission of buy orders from a customer of the exchange member 500. The “buyer's currency” in the description to follow is the currency selected by the buyer as his/her settlement monetary unit. A seller client 550b is a client computer or module/interface used by a seller in a currency trade. The seller client 550b is in communication with an exchange member 500, and facilitates submission of sell orders from a customer of the exchange member 500. The “seller's currency” is the currency selected by the seller as his/her settlement monetary unit.

Each exchange member 500 has a member's clearing account (“member account”) 220 on the central clearer 200, allowing the member to clear transactions upon execution of trades.

The components described above with respect to FIG. 1 cooperate to create an advantageous multi-currency clearing environment in which customers wishing to trade in a currency not supported by the exchange can trade as if the entire trade is in the currency of their choice. This is achieved by linking a currency trading facility, in this case the FX ECN 300, with an exchange 100 by the multi-currency interface (MCI) 400. In operation, exchange members 500, or their customers, connect to the MCI 400. The MCI 400 is configured and programmed to make reference to Spot FX rates generated by the FX ECN 300 to make available to the exchange members/customers quotes, i.e., a listing, for securities traded on the exchange quoted in any currency selected by the customer, regardless of whether the customer's currency is the exchange quoted currency. Preferably, the exchange 100 will approve what currency's securities can be listed and viewed by customers.

In the multi-currency trading method, according to one aspect of the present invention, when the exchange member 500 or its customer, via a buyer or seller client, submits a trade request to the exchange 100, the MCI 400 determines Spot FX rates that need to be used to convert the quotes of the securities on the exchange 100 so as to be able to publish these quotes to the exchange's customers, but quoted in the currencies selected by these customers.

Once a security trade is matched on the exchange 100, the MCI 400 determines what Spot FX transactions have to take place to facilitate the multi-currency transaction and clearing process. Once this has been determined, the MCI 400 submits orders to the FX ECN 300 to execute such trades.

The internal matching agent 320 of the FX ECN 300 performs internal matching and books the orders. Preferably, the matches are made at a mid-point price, that is, a price at the mid-point between the buy and ask price. The Spot FX trades executed on the FX ECN 300 to facilitate the multi-currency conversions will preferably be invisible to the central clearer 200. The central clearer 200 will receive trade execution notifications based in the clearing currency, and the central clearer 200 will credit and debit the exchange members' accounts 220 in the clearing currency, as part the clearing process, as discussed in more detail below.

The MCI module 400 is in electronic communication with the FX ECN 300, including the internal matching agent 320, as well as with the exchange 100 and with trading interfaces of customers, such as the buyer client 550a and seller client 550b, connected to the exchange 100. The MCI 400 is configured and programmed to calculate on the fly price conversions to display any instrument in any currency selected by a customer, and submit trades to FX ECN 300 to execute any transactions necessary to facilitate conversions of currencies between buyer and seller of securities and the central clearer 200.

All communication between the exchange 100 and its customers flows through the MCI 400. If there is no need for translating the quotes or trading orders from one currency to another, for example, when the buyer or seller are using the exchange currency, the MCI 400 is configured and programmed to pass orders or quotes through to the exchange 100 as is.

In accordance with the preferred implementation of the present invention, the FX ECN 300 comprises one or more computers configured and programmed to execute trades submitted by the MCI 400 that are necessary to perform all currency conversions to facilitate multi-currency security trades. Whenever possible, the IMA 320 internally matches orders submitted by the MCI 400 to the FX ECN 300 at a mid-point price, as described above.

The MCI 400 is also configured and programmed to receive all trade confirmations from the FX ECN 300 and generate, publish and deliver all of the messages necessary to facilitate the clearing of multi-currency security trades and necessary movement of physical cash of required currencies.

Since, in many scenarios, trades will have to be made on the FX ECN 300 to effect translation between different currencies, it will be necessary for each exchange member 500 to have an account with the FX ECN 300. The MCI 400 is preferably implemented so as to be integrated into a quote application programming interface API of the exchange 100. The MCI 400 is also preferably integrated into a trading API of the exchange 100. Each customer would have to specify what currency they would like to see on their terminal. For instance, if a customer selects currency B as a display currency, every time a security quoted is published on exchange 100 in currency A MCI 400 will request a quote from FX ECN 300 to convert currency A into currency B and MCI 400 will use this quote to display price for the security in currency B for the customer. As discussed above, the internal matching agent 320 preferably forms a part of the FX ECN 300.

There are a multitude of possible embodiments for this process. Scenario one covers the most complicated scenario, where all currencies are different and all needed actions must be taken to effect the trades in their own currencies. Any other permutation would simply use fewer steps to achieve the same result. Some such scenarios are demonstrated in the example scenarios described below, and can be applied to other possible scenarios.

A number of exemplary trading scenarios will next be described with reference to FIGS. 2-6 to illustrate how the system for multi-currency trading works, and the interactions between the various elements shown in FIG. 1. In the first, most complicated, scenario, as shown in FIG. 2, the seller's currency (Currency A) is different from the exchange quoted currency (Currency B) and is also different from the buyer's currency (Currency C) and different from clearing currency (Currency D).

In this scenario, the seller of the securities offers to sell his/her securities denominated in Currency A. However, as the seller's security has to be quoted on the exchange in Currency B, the Currency A amount has to be converted to a Currency B amount in order to publish a quote for this security on the exchange. This conversion is achieved by the MCI 400 using the FX ECN Index Prices provided by the FX ECN 300 to calculate currency conversion price on the fly from Currency A to Currency B.

Next, the MCI 400 uses this calculated price to buy Currency B vs. Currency A (long Currency B/short Currency A) on the FX ECN 300. If such pair is not quoted directly in the FX ECN 300, the MCI 400 will create a synthetic price by buying Currency B against one of the major currency pairs, such as the U.S. Dollar or the Euro and selling Currency A against the same major currency.

In this scenario, from the point of view of the buyer, the buyer desires to see prices of said security quoted in their chosen currency (Currency C). This is achieved by the MCI 400 using the FX ECN Index Prices provided by FX ECN 300 to calculate a currency conversion price on the fly from Currency B to Currency C. The MCI 400 uses this calculated price to buy Currency C vs. Currency B (long Currency C/short Currency B) on the FX ECN 300. If such pair is not quoted directly in FX ECN 300, the MCI 400 will create a synthetic price by buying Currency C against one of the major currency pairs such as the U.S. Dollar or the Euro and selling Currency B against the same major currency.

The buyer can place his/her own order to buy said security specifying the price he/she is willing to pay for said security denominating the price in Currency C. The buyer's quote has to be published on the exchange in Currency B. This is achieved by the MCI 400 using the FX ECN Index Prices provided by the FX ECN 300 to calculate currency conversion price on the fly from Currency C to Currency B. The MCI 400 uses the calculated price to buy Currency B vs. Currency C (long Currency B/short Currency C) on the FX ECN 300. If such pair is not quoted directly in the FX ECN 300, the MCI 400 creates a synthetic price by buying Currency B against one of the major currency pairs such as the U.S. Dollar or the Euro and selling Currency C against the same major currency.

When the buyer and seller orders are matched on the exchange 100, where both orders appear denominated in Currency B, the trade will be executed on the exchange 100. The exchange 100 the sends trade confirmation messages back to both customers through the MCI 400.

To support such a trade and to deliver clearing currency (Currency D) to the central clearer 200, the MCI 400 executes the following Spot FX trades:

(1) The MCI 400, on behalf of the buyer in this scenario, submits the order to sell Currency C and buy Currency D in the FX ECN 300. The resulting trade creates the amount of Currency D necessary to settle this transaction in Buyer's prime brokerage account.

(2) The MCI 400, on behalf of the seller in this scenario, submits the order to sell Currency D and buy Currency A in the ECN 300. Once settled, this trade creates in the seller's prime brokerage account a negative amount of Currency D equal to the amount paid for the security by the buyer and positive amount in Currency A equal to the amount expected by the seller in exchange for sold security. The seller or his clearing broker then delivers sold securities to the central clearer 200.

Once the central clearer 200 receives both Currency D cash from the buyer and securities from the seller:

The central clearer delivers securities to the buyer and Currency D to the seller. The Currency D received by the seller will net the negative Currency D amount held in seller's prime brokerage account, leaving the seller with positive Currency A amount, which is exactly what the seller would expect to receive for selling the security. Finally, the buyer receives the security that he/she paid for with Currency C.

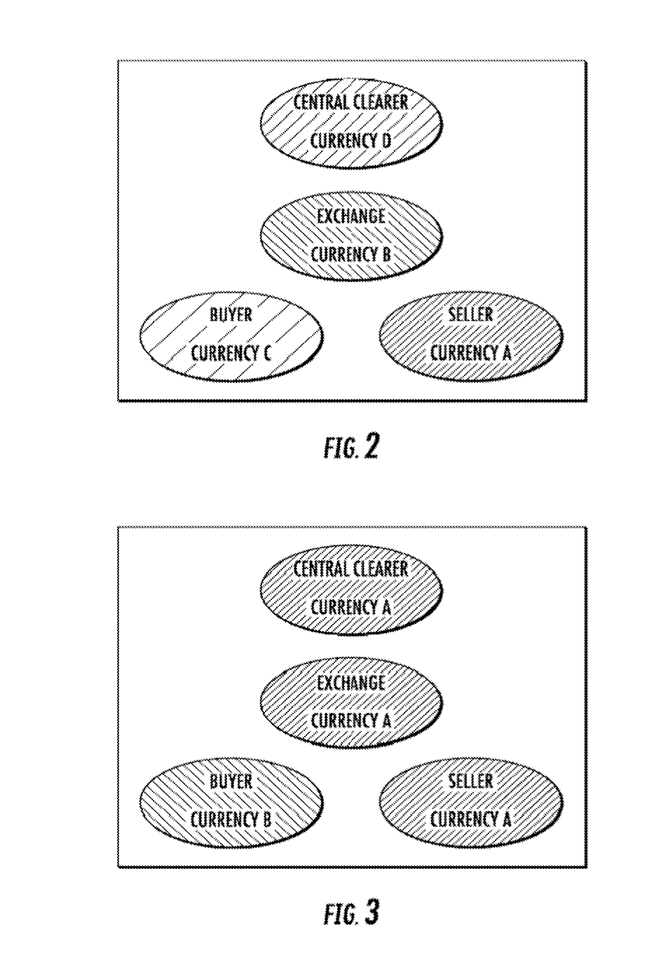

In a second illustrated scenario, shown with reference to FIG. 3, the seller's currency is the same as the exchange quoted currency and is also the same as the clearing currency (Currency A). However, in this case, the buyer's currency is different from seller's currency (Currency B).

In this scenario, the seller of the securities offers to sell his/her securities denominated in Currency A. As this is the exchange quoted currency, no conversion is necessary and the order can be placed on the exchange without conversion.

The buyer will see prices of said security quoted in the currency he/she selected (Currency B). This is achieved by the MCI 400 using the FX ECN Index Prices provided by the FX ECN 300 to calculate a currency conversion price on the fly from Currency A to Currency B. The MCI 400 uses this calculated price to buy Currency B vs. Currency A (long Currency B/Currency A) on the FX ECN 300. If such pair is not quoted directly in the FX ECN 300, the MCI 400 will create a synthetic price by buying Currency B against one of the major currency pairs such as the U.S. Dollar or the Euro and selling Currency A against the same major currency.

In this second scenario, the buyer can place his/her own order to buy said security specifying the price he/she is willing to pay for said security denominating the price in Currency B. However, the buyer's quote has to be published on the exchange 100 in Currency A. This is achieved by the MCI 400 using the FX ECN Index Prices provided by the FX ECN 300 to calculate a currency conversion price on the fly from Currency B to Currency A. The MCI 400 then uses this calculated price to buy Currency A vs. Currency B (long Currency A/short Currency B) on the FX ECN 300. If such pair is not quoted directly in the FX ECN 300, the MCI 400 creates a synthetic price by buying Currency A against one of the major currency pairs such as the U.S. Dollar or the Euro and selling Currency B against the same major currency.

When the buyer and seller orders are matched on the exchange 100, where both orders appear denominated in Currency A, the trade will be executed on the exchange 100. The exchange 100 will then send trade confirmation messages back to both customers through the MCI 400.

For the seller in this scenario, the MCI 400 does not have to take any additional currency trades and it will pass the trade confirmation message to the seller as it was received from the exchange 100 and the seller will transfer sold securities to the central clearer 200.

For the buyer in this scenario the MCI 400 submits the order to buy clearing currency (Currency A) and sell Currency B on the FX ECN 300. The buyer will buy clearing currency (Currency A) and sell Currency B on the FX ECN 300. The buyer will let this trade settle in his prime brokerage account and then will transfer clearing currency (Currency A) from his prime brokerage account to the central clearer 200. The central clearer 200 can then transfer the securities to the Buyer's account and transfer clearing currency to the seller's central clearing account.

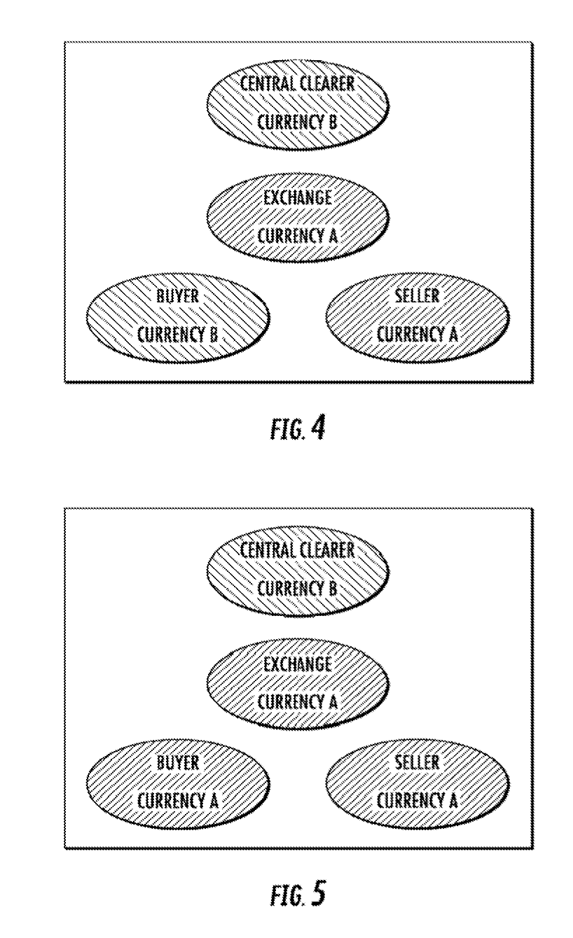

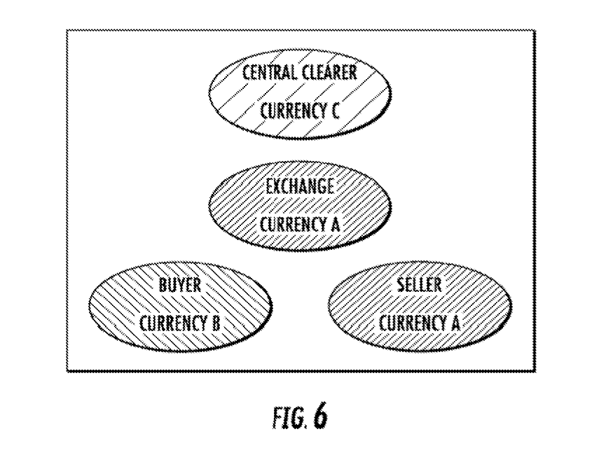

In a third illustrated scenario, shown with reference to FIG. 4, the seller's currency is the same as the exchange quoted currency (Currency A). The buyer's currency is the same as the clearing currency (Currency B). However, in this case, the buyer's currency (Currency B) is different from the seller's currency (Currency A).

In this third scenario, the seller of the securities will offer to sell his/her securities denominated in the exchange quoted currency, so no conversion is necessary for the seller's order to be published on the exchange.

The buyer will see prices of said security quoted in the currency he/she selected (Currency B). This is achieved by the MCI 400 using the FX ECN Index Prices provided by FX ECN 300 to calculate a currency conversion price on the fly from Currency A to Currency B. The MCI 400 uses the calculated price to buy Currency B vs. Currency A (long Currency B/short Currency A). If such pair is not quoted directly in the FX ECN 300, the MCI 400 creates a synthetic price by buying Currency B against one of the major currency pairs such as the U.S. Dollar or the Euro and selling Currency A against the same major currency.

The buyer can place his/her own order to buy said security specifying the price he/she is willing to pay for said security denominating the price in Currency B. This buyer's order will be processed through the MCI 400, where the MCI 400 will convert this order from Currency B to the exchange quoted currency (Currency A) and submit order to buy security denominated in the exchange quoted currency to the exchange 100.

When the trade is executed on the exchange 100, the exchange 100 will send a trade confirmation messages back to both customers through the MCI 400. For the buyer in this scenario, the MCI 400 does not have to execute any additional currency trades and it will pass the trade confirmation message to the buyer as it was received from the exchange 100. The buyer then transfers Currency B (clearing currency) to the central clearer 200 to settle this securities transaction.

For the seller in this scenario, the MCI 400 submits the order to buy Currency A and sell Currency B on the FX ECN 300. The seller submits securities to central clearer 200 for settlement. The central clearer 200 can then transfer the securities to the buyer's account and transfer clearing currency to the seller's Account. Once the transfer of Currency B physical cash from central clearer 200 to the seller's account is complete, the seller will let the Spot FX trade to buy Currency A and sell Currency B settled in his prime brokerage account, after which the seller will be able to take the delivery of the Currency A.

In a fourth illustrated scenario, shown with reference to FIG. 5, the seller's currency is the same as the buyer's currency and the exchange quoted currency (Currency A). The buyer's currency and the seller's currency are different from the clearing currency (Currency B).

In this scenario, the seller of the securities will offer to sell his/her securities denominated in the exchange quoted currency, and the buyer will see prices of said security quoted in the exchange quoted currency. The buyer can place his/her own order to buy said security specifying the price he/she is willing to pay for said security denominating the price in Currency A. When the trade is executed on the exchange 100, the exchange 100 will send trade confirmation messages back to both customers through the MCI 300.

For the buyer in this scenario, the MCI 400 submits the order to sell Currency A and buy Currency B in the FX ECN 300. The buyer will transfer Currency B physical cash to the central clearer 200, and the seller will transfer the securities to the central clearer 200. The central clearer 200 can then transfer the securities to the buyer's account and transfer clearing currency to the seller's account.

For the seller in this scenario, the MCI 400 submits the order to buy Currency A and sell Currency B on the ECN 300. Once the transfer of Currency B physical cash from central clearer 200 to the seller's prime brokerage account is complete, the seller will let the trade to buy Currency A and sell Currency B settled in his prime brokerage account, at which time the seller will be able to take the delivery of the Currency A.

### Internal Matching Alternative for Scenario Four

Since in this scenario both the buyer and the seller wish to transact in Currency A, but the Central Clearer is required to transact in Currency B, instead of making two trades in the FX ECN 300 (i.e., the buyer sells Currency A and buys Currency B and the seller sells Currency B and buys Currency A), the internal matching agent 320 can be utilized to book a “give-up trade” between the seller's prime brokerage account and the buyer's prime brokerage account in which: the buyer sells Currency A and buys Currency B at the mid-point between bid and offer for Currency A vs. Currency B pair published in the FX ECN 300, and seller buys Currency A and sells Currency B at the same price. This option has the advantage of saving money for both the buyer and seller and decreases the settlement risk.

In a fifth illustrated scenario, shown with reference to FIG. 6, the seller's currency is the same as the exchange quoted currency (Currency A). The buyer's currency (Currency B) is different from the seller's currency. Both the buyer's currency and the seller's currency are different from the clearing currency (Currency C).

In this scenario, the seller of the securities will offer to sell his/her securities denominated in the exchange quoted currency (Currency A), while the buyer will see prices for said security quoted in their chosen currency (Currency B). This will be achieved by the MCI 400 using the FX ECN Index Prices provided by FX ECN 300 to calculate a currency conversion price on the fly from Currency A to Currency B. The MCI 400 uses the calculated price to buy Currency B vs. Currency A (long Currency B/short Currency A) on the FX ECN 300. If such pair is not quoted directly in the FX ECN 300, the MCI 400 creates a synthetic price by buying Currency B against one of the major currency pairs such as the U.S. Dollar or the Euro and selling Currency A against the same major currency.

The buyer can place his/her own order to buy said security specifying the price he/she is willing to pay for said security denominating the price in Currency B. The buyer's quote is published on the exchange in Currency A. This will be achieved by the MCI 400 using the FX ECN Index Prices provided by the FX ECN 300 to calculate a currency conversion price on the fly from Currency B to Currency A. The MCI 400 uses the price to buy Currency A vs. Currency B (long Currency A/short Currency B) on the FX ECN 300. If such pair is not quoted directly in the FX ECN 300, the MCI 400 creates a synthetic price by buying Currency A against one of the major currency pairs such as the U.S. Dollar or the Euro and selling Currency B against the same major currency.

When the trade is executed on the exchange 100, the exchange 100 sends trade confirmation messages back to both customers through the MCI 400. For the buyer in this scenario, the MCI 400 submits the order to sell Currency B and buy Currency C on the FX ECN 300. The buyer will then be able to deliver currency C to the central clearer for clearing.

For the seller in this scenario, the MCI 400 will submit the order to buy Currency A and sell Currency C on the FX ECN 300. The seller will deliver sold securities to the central clearer 200, and the central clearer can then transfer the securities to the buyer's account and transfer clearing currency to the seller's account. Once the transfer of Currency C physical cash from central clearer 200 to the seller's account is complete, the seller will trade to buy Currency A and sell Currency C settled in his prime brokerage account, and the seller will be able to take the delivery of the Currency A.

### Internal Matching Alternative for Scenario Five

In this scenario the buyer and the seller are desirous to transact in currencies different from a currency used as a central clearing currency. Instead of making two trades in the FX ECN 300 (i.e., the buyer sells Currency A and buys Currency C and seller sells Currency C and buys Currency A), a single trade can be made in the FX ECN 300 and the internal matching agent module 320 can be used to book a “give-up trade” between the seller's prime brokerage account and the buyer's prime brokerage account to achieve the same goals:

That is, the MCI 400 executes in the FX ECN 300 one trade in which:
the buyer sells Currency B and buys Currency A. The IMA 320 will book a give up trade between Buyer and the Seller;
the buyer buys Currency C and sells Currency A; and
the seller sells Currency C and buys Currency A.

In this manner, instead of executing two trades in the FX ECN 300 and paying the spread twice, only one trade would be executed in the FX ECN 300 and a give-up trade is booked at the mid-point between bid and offer for the Currency A vs. Currency B pair published in FX ECN 300. Savings from executing the give-up trade at the mid-point could, for example, be shared between the buyer and the seller.

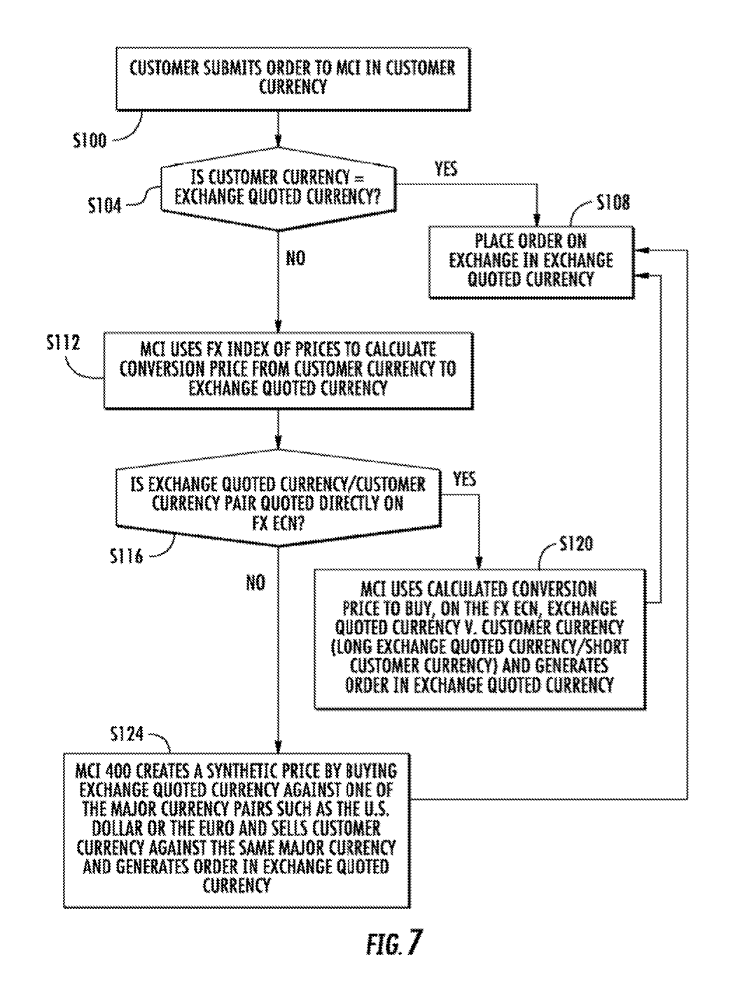

FIG. 7 is a flowchart showing the processing required for the MCI 400 to convert customer (either seller or buyer) orders so that they may be published on the exchange 100. In step S100, the customer submits an order to the MCI 400 in the customer's currency (i.e., seller's currency or buyer's currency, depending on whether the customer is a seller or a buyer). In step S104, it is determined whether the customer currency is equal to (i.e., the same as) the exchange quoted currency. If it is the same, then at step S108 the order is published on the exchange 100 in the exchange quoted currency.

If the answer is no, then at step S112, the MCI 400 uses the FX index prices of RX ECN 300 to calculate a conversion price from the customer currency to the exchange quoted currency. Next, at step S116, it is determined if the exchange quoted currency/customer currency pair is quoted directly on the FX ECN 300. If yes, the flow proceeds to step S120 in which the MCI 400 uses calculated conversion price to buy, on the FX ECN 300, exchange quoted currency v. customer currency (long exchange quoted currency/short customer currency) and generates an order in exchange quoted currency. The flow then proceeds to step S108 where the generated order is placed on the exchange 100.

If the answer to the determination at step S116 is no, then, at step S124, the MCI 400 creates a synthetic price by buying exchange quoted currency against one of the major currency pairs such as the U.S. dollar or the Euro and selling customer currency against the same major currency and generates an order in the exchange quoted currency. Then flow proceeds to step S108 where the generated order is placed on the exchange 100.

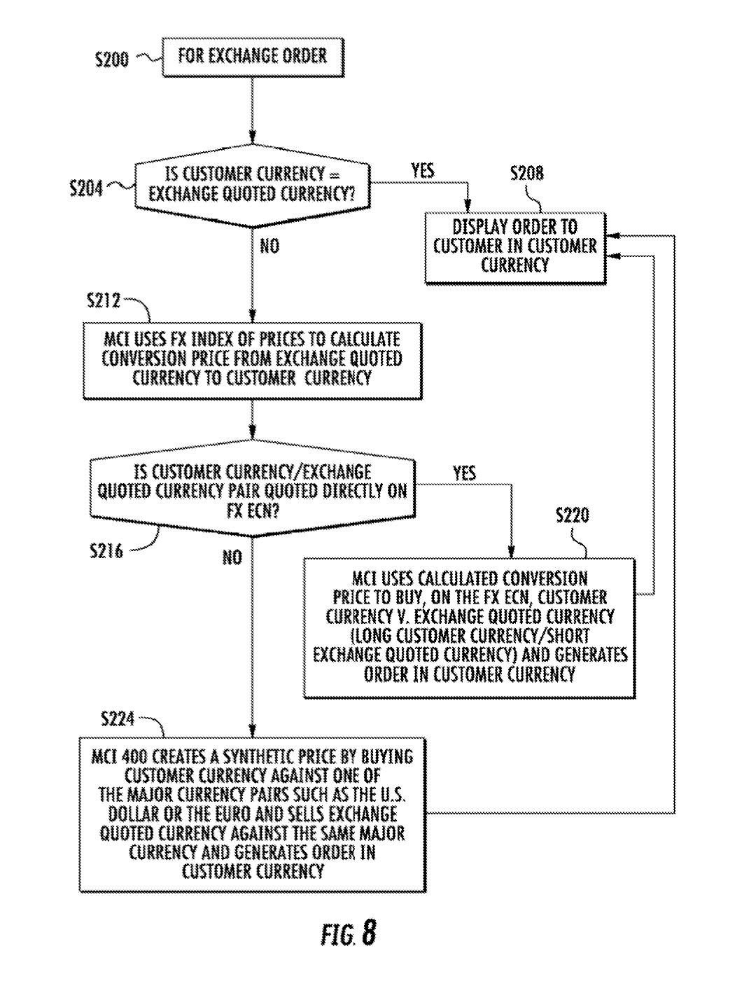

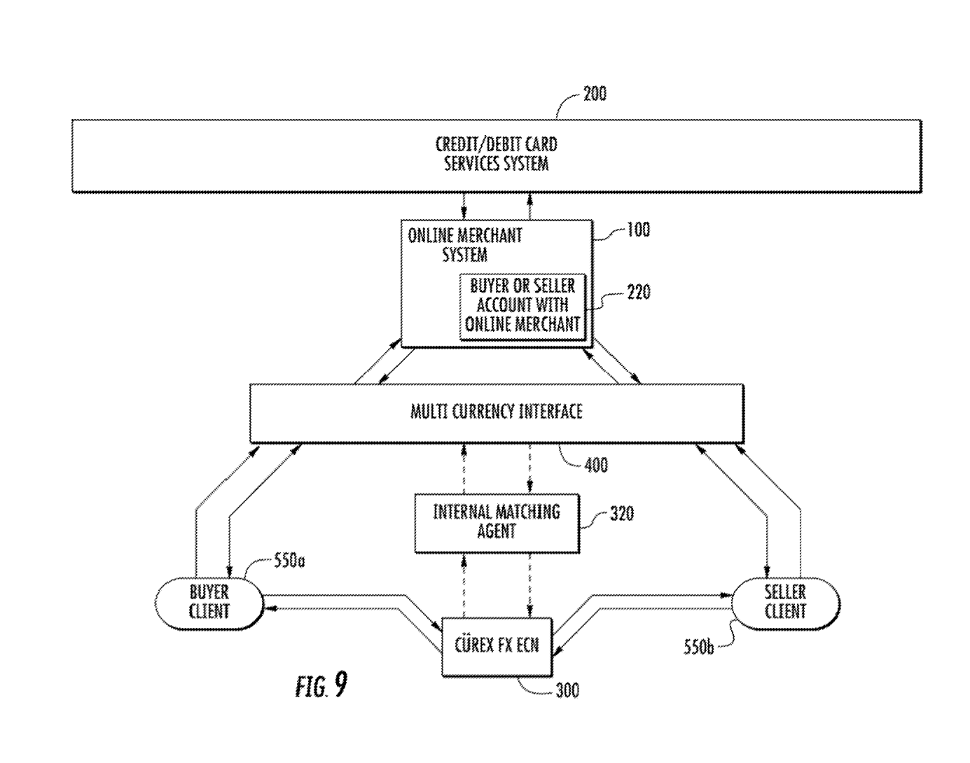

FIG. 8 is a flowchart showing the processing required for the MCI 400 to convert orders on the exchange 100 to a customer (either seller or buyer) order so that the customer may see the orders on the exchange in their customer currency (seller's currency or buyer's currency, as the case may be). In step S200, the MCI 400 takes up an exchange order for processing. In step S204, it is determined whether the customer currency is equal to (i.e., the same as) the exchange quoted currency. If it is the same, then at step S208 the order is displayed to the customer at the customer currency, which is the same as the exchange quoted currency.

If the answer is no, then at step S212, the MCI 400 uses the FX index of prices to calculate a conversion price from the exchange quoted currency to the customer currency. Next, at step S216, it is determined if the customer currency/exchange quoted currency pair is quoted directly on the FX ECN 300. If yes, the flow proceeds to step S220 in which the MCI 400 uses calculated conversion price to buy, on the FX ECN 300, customer currency v. exchange quoted currency (long customer currency/short exchange quoted currency) and generates an order in the customer currency. The flow then proceeds to step S208 where the generated order is displayed to the customer.

If the answer to the determination at step S216 is no, then, at step S224, the MCI 400 creates a synthetic price by buying customer currency against one of the major currency pairs such as the U.S. dollar or the Euro and selling exchange quoted currency against the same major currency and generates an order in the customer currency. Then flow proceeds to step S208 where the generated order is displayed to the customer.

The above-described system as represented in FIG. 1, and the other structures described hereinafter, can be implemented in digital electronic circuitry, or in computer hardware, firmware, software, or in combinations of them. The implementation can be as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps as described herein can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Machine readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

To provide for interaction with a consumer, any terminals that might be associated with, e.g., the buyer or the seller can be computers having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described system can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components.

The components of the system described above can be interconnected by any form or medium of digital data communications, e.g., a communications network. Examples of communications networks, also referred to as communications channels include a local area network (“LAN”) and a wide area network (“WAN”), e.g., the Internet, and include both wired and wireless networks. Unless clearly indicated otherwise, communications networks can also include all or a portion of the PSTN, for example, a portion owned by a specific carrier.

The computing system of FIG. 1 as described above includes clients and servers. A client and server are generally remote from each other and typically interact through a communications network. The relationship of client and server arises by virtue of computer programs running on the respective computers and having a client-server relationship to each other.

As noted above, the methods and systems described above can be implemented with trading systems or Electronic Communication Networks (ECN) for trading any financial instrument, including currency, and are not limited to trading currencies.

For example, the methods and systems described above can be implemented with the methods and systems described in co-pending applications of commonly owned by Applicants' assignee, including, U.S. patent application Ser. No. 12/750,670, entitled Hybrid OTC FX/FX ETF Primary Market Electronic Communication Network Technology Processing Systems And Methods For Offering, Trading, Issuing, Creating, Redeeming And Clearing Foreign Exchange Based Exchange Traded Funds And Creating, Calculating And Publishing Foreign Exchange Index And Tracking The Value Of Foreign Exchange Rates, filed Mar. 30, 2010, and U.S. patent application Ser. No. 12/274,319, entitled Systems And Methods For Creation, Issuance, Redemption, Conversion, Offering, Trading, And Clearing A Debt Obligation Convertible Into Cash Plus A Spot Foreign Exchange Contract That Is Priced To Reflect The Value Of The Debt Obligation In A Base Currency In Relation To The Value Of A Reference Currency, filed Nov. 19, 2008.

Customers, such as buyers and sellers, preferably use trading terminals to perform methods described above and interact with systems described above. Trading terminals can be computers having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element), can be used. Other kinds of devices can be used; for example, feedback provided to the user can be any form of sensory feedback, e.g., visual feedback, auditory feedback, or tactile feedback; and input from the user can be received in any form, including acoustic, speech, or tactile input. It is also preferable to use computers having a display device to receive and send data and to process data and perform calculations to facilitate execution of their functions.

The trading terminals have trade execution graphical user interfaces (GUI) or (Application Programming Interfaces (API). The trade execution GUI or API preferably performs exemplary functions and capabilities that include the ability to receive information concerning trade orders (bids and offers) that are broadcasted to eligible liquidity providers and consumers, including order price, order amount, order time, order rank or position, and order holding time holding time for resting orders. A GUI or API for order entry using the systems and methods described above also would include functions for modifying or canceling orders and the ability to receive messages concerning offer holding periods, execution and cancellation of orders, and compliance with execution auction system rules. These functions can be arranged in a multitude of ways. The order entry screen can be customized with regard to type of data presented or the order in which the data is presented to suit an individual trader's needs according to methods known to those skilled in the art as well as those that have not been invented yet. The order entry screen GUI or API also can contain a password or other security protection function to enable access to trade financial instruments according to the methods and systems described herein. Communications sent to and received at trading terminals on which the order entry screen is generated can be encrypted.

The above examples are described making reference to a “seller's [or buyer's] currency.” In accordance with the present invention, the seller and buyer may select their currency by communicating their preference to, for example, the exchange 100, either directly or indirectly. Thus, for example, the seller's or buyer's currency may change, according to the expressed preference of the customer.

Moreover, while a particular currency is associated with a buyer or seller in the above examples, preferably the seller or buyer can select, e.g., subscribe to, more than one preferred currency, both for seeing orders and for being able to submit orders. As would be appreciated, the above techniques would simply be performed multiple times to provide this functionality to a customer wishing to deal in more than one currency. For example, by having multiple terminals as the customer location, one acting as a USD terminal and one acting as an EUR terminal. However, the present invention is not limited to this manner of implementation.

In embodiments described above, the equity transaction and FX transaction happen sequentially, with FX transaction taking place with right after the securities transaction is executed. In this case, the price achieved for the FX transaction is not guaranteed to be the same price as was used to calculate the conversion of the customer quote from the customer currency to the exchange quoted currency, unless buyer and seller of the security are matched with one another to execute FX transaction. In any other scenario, it is not possible to guaranty the price of the FX transaction at the time of placing a security's order.

In another embodiment, the multi-currency interface could be specifically programmed for a new order type: a limit order in customer currency. This order submitted by the customer will be submitted as a limit order for a financial instrument expressed in the customer currency. Performing the following steps will guaranty the execution of the order at the specified limit price in customer currency or better:

The multi-currency interface 400 will receive such a limit order in the customer currency and will start the process of monitoring available liquidity on both exchange and FX trading platform.

At the beginning of the process and every time a new price is published on the exchange in exchange quoted currency is published, the multi-currency interface would be specifically programmed to request automatically a price available on the FX trading platform to convert the customer order in customer currency into exchange quoted currency and will convert the customer order in customer currency into exchange quoted currency or every time new price on FX trading platform is published multi-currency interface would request the current price on the exchange for the security in exchange quoted currency and will convert the customer order in customer currency into exchange quoted currency.

Conversely, the price of the new order on the exchange can be converted to the customer currency and price comparison can be performed using the customer limit order price in customer currency and exchange order price converted to the customer currency.

If the calculated price in the exchange quoted currency for the customer order is equal or better than the price for security available on the exchange in exchange quoted currency, multi-currency interface will be programmed to submit the FX conversion order to the FX trading platform for a pre-match order.

Once the pre-match FX order is acknowledged, the multi-currency interface 400 will submit a limit order in exchange quoted currency to the Exchange 100. The FX ECN 300 is specifically programmed to validate the pre-match order and the internal matching agent 320, which is preferably part of FX ECN 300, performs the matching process to the point of sending confirmations of the trade to the counterparties while waiting for the confirmation of the trade on the Exchange 100 to come in.

Another benefit of performing all the activities of executing the match while waiting for the exchange trade confirmation is improvements of the overall time of the execution of the two orders (the Exchange trade and the FX trade).

When the order execution on the exchange is confirmed, multi-currency interface 400 will submit a message to the FX ECN 300 to finish execution of the FX trade.

Execution of the FX order at the FX rate originally used in pricing the order in customer currency will guarantee the limit price in the customer currency to be at or better of the original customer price.

Alternatively, if participants in the FX ECN 300 used to implement this functionality could be asked to honor their prices for a predetermined period of time (Execution Time) after submitting a new price to the FX trading platform or after submitting a price cancellation order to the FX trading platform, or even after another trade would utilize the this order. In this scenario the following steps will be taken:

Confirm that original FX quote to convert customer currency into exchange quoted currency is still available on the FX trading platform.

If the original quote is still available the multi-currency interface 400 will submit a limit order in exchange quoted currency to the Exchange 100. When the order execution on the exchange is confirmed, multi-currency interface will submit the limit FX order to the FX ECN 300 to be executed against the original FX quote. Execution of the FX order at the original price level will guarantee the limit price in the customer currency;

In another embodiment, MCI 400 can be specifically programmed for use in more traditional commercial transactions, regardless of whether these transactions take place online or offline. Many traditional online marketplaces, such as eBay or Amazon, do not operate in a multi-currency environment. Some online marketplaces that do operate in a multicurrency environment may let customers place their own goods or services for sale in the seller's currency but show only an indicative price in the buyer's currency. And in such case the source of the FX conversion price used to convert the seller currency to the buyer's currency is not disclosed and is not verifiable.

All currency conversion risk in many cases falls on the buyers in such transactions. Customers either have to take risk and purchase the goods or services without knowing the final price in buyer's local currency or customer have to rely on the company that runs the online marketplace or the payment processing company to convert seller's price from the seller's currency into buyer's currency for the final payment. When a payment processing company provides the conversion, there is a lack of transparency and disclosure with regard to the conversion process and ultimate conversion rates obtained. Payment processing companies that provide such a service are often generate outsized profits doing so often at the expense of the buyers and sellers. Marketplace operators or payment system operators convert prices from the seller currency to the buyer currency using excessive spreads, relying on the excuse that they need to cover potential risk associated with currency price movement in performing the conversions. But in reality, these excessive spreads result in oversized profits for the companies.

There is a need for a real-time, transparent and disclosed currency conversion process to support marketplaces for physical goods and services and also there is a need to provide such marketplaces and payment systems with operational multi-currency capability.

The multi-currency interface 400 and methods and systems described above in FIG. 1 can be modified as presented in FIG. 9 to provide such capabilities to any marketplace or payment system where physical goods and services and even virtual goods and services are bought and sold.

The multi-currency interface 400 of FIG. 9 can be configured and programmed to facilitate multi-currency transactions where physical goods and services and virtual goods and services are bought and sold. Exchange 100 in FIG. 1 could be replaced by a payment system or a marketplace as depicted by Online Merchant System 100 in FIG. 9 and the “security” as described above in embodiments referring to FIG. 1, could be replaced by physical or virtual goods or services. Goods or services could be offered for sale in one currency (seller currency) on Online Merchant System 100 in FIG. 9 that operates in a different currency (marketplace quoted currency) and a buyer could be placing orders through Buyer Client 550a in FIG. 9 to procure goods and services using the buyer's currency.

As with the financial services as described with reference to FIG. 1, multi-currency interface 400 of FIG. 9 could be used to convert in real time the price in seller's currency into the buyer's currency to display a definitive price for the buyer. The price in buyer's currency would be updated in real time every time the seller changes the price or the conversion price between the buyer's currency and seller's currency changes on FX ECN 300 as described above. And when the buyer commits to the transaction, the same price used to perform the conversion to display the price in buyer's currency will be used to perform the actual conversion of the currencies for the buyer to pay for the goods or services as described above with reference to FIG. 1. The conversion from the buyer's currency to the seller's currency could also be performed by executing the trade between the buyer and the seller at a single price point, for instance at a midpoint price for this currency pair as described above with reference to FIG. 1.

The multi-currency interface 400 as depicted in FIG. 9 can be configured and programmed to allow a buyer of the goods or services to perform a multi-currency search for the goods or services listed in different currencies. Buyers can enter prices for a specific item in buyer's currency and the multi-currency interface 400 of FIG. 9 will convert the buyer's price into a multitude of currencies in which sellers have listed similar products for sale. Online Merchant System 100 would be configured and programmed to search similar products offered for sale in seller currencies to find the best price for the buyer. The buyer's offer to buy a product or service in a buyer's currency could be also converted to the marketplace quoted currency and listed on the marketplace for other participants to see. The multi-currency interface 400 of FIG. 9 will also be used in this case to convert the buyer's price into a chosen currency of each seller to show seller the offer to buy in the seller's own currency.

Additionally, the multi-currency interface 400 of FIG. 9 could be used to implement currency conversion to effectuate a money transfer in a multi-currency environment. Where a customer who is a sender of money could indicate in his own currency amount to be sent and the receiver of the transfer could see the amount expected in his own currency before he would agree to the transfer, or the transfer could happen automatically without receiver accepting the transfer. The conversion from the sender currency to the receiver currency could also be performed by executing the trade between the sender and receiver at a single price point, for instance at a midpoint price for this currency pair.

With regard to FIG. 9, Online Merchant System 100 can be configured and programmed to offers goods and services for sale in one currency but permit buyers and sellers to view merchandise or services and pay for them in the customer's own currency. MCI 400 of FIG. 9 also could be configured and programmed with Online Merchant System 100 to permit independent sellers to offer goods and services for sale in seller's currency and let buyers view and purchase merchandise or services in buyer's currency. In both of these scenarios, the functionality outlined in FIG. 9 would be performed by the following entities:

Credit/Debit Card Services Bank System 200—The role of Central Clearer 200 as described with reference to FIG. 1 would be performed by the computer system bank that provides credit or debit card clearing services or by the Online Merchant System 100 itself.

Buyer Or Seller Accounts With Online Merchant 220 function in the same way as equivalent of Member Account 220 described in FIG. 1 with the Central Clearer 200 of FIG. 1 being replaced by Buyer or Seller Account With Online Merchant 220.

Exchange 100—The role of Exchange 100 described in FIG. 1 above would be the Online Merchant System 100 that is either offering products or services for sale in its own name or offering a platform to sell products or services.

Multi Currency Interface 400 would function as described with reference to FIG. 1 in the same manner in the system depicted in FIG. 9.

Internal Matching Agent 320 would function in the same manner as described with reference to FIG. 1 for the system described with reference to FIG. 9.

Exchange Member 500 as described in FIG. 1 would normally be an exchange member (broker) that provides customer with access to the exchange, exchange members also sometimes provide credit and connectivity to the exchange. In the case of the FIG. 9 system Online Merchant System 100 customers will have direct access to the Online Merchant System 100, in which case the

online Merchant System 100 itself would provide the access to end users through Buyer Client 550a and Seller Client 550b. Alternatively, there could be another merchant that provides customer access to the marketplace.

The Member's PB 600 and Exchange Member 500 as described with reference to FIG. 1 would be unnecessary in the system depicted in FIG. 9 because the Online Merchant System itself would be performing the functions of Exchange Member 500 and providing prime broker like services. In the online commerce system of FIG. 9, these services would include account handling services.

Cürex FX ECN 300 would function in the same manner as described with reference to FIG. 1, with regard to the system depicted in FIG. 9, providing online merchant eco-system access to the FX market price discovery and trading.

The invention has been described in terms of particular embodiments. The alternatives described herein are examples for illustration only and not to limit the alternatives in any way. The steps of the invention can be performed in a different order and still achieve desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A computerized method for trading financial instruments in multiple currencies, the method comprising:
receiving a limit order from at least one customer for a financial instrument, including a price and a quantity denominated in a customer currency, at a multi-currency interface comprising one or more server computers executing on one or more processors in communication with (a) a computerized trading exchange system that trades the financial instrument denominated in an exchange quoted currency and (b) a foreign exchange (“FX”) trading platform;
electronically monitoring available liquidity on the computerized trading exchange and the FX trading platform at the multi-currency interface;
when a new price is published on the computerized trading exchange in the exchange quoted currency for the financial instrument, automatically requesting available prices on the FX trading platform;
receiving the available prices on the FX trading platform at the multicurrency interface;
calculating at the multi-currency interface a price in the exchange quoted currency for converting the limit order in the customer currency to the exchange quoted currency based upon real time spot tradable index prices published by the FX trading platform;
determining whether the conversion price is still available on the FX trading platform;
and converting the limit order in the customer currency to the exchange quoted currency based on real time spot tradable index prices published by the FX trading platform.

2. The method of claim 1, further comprising comparing the calculated conversion price in the exchange quoted currency for the limit order to a price for the financial instrument on the exchange in the exchange quoted currency; and
if the calculated conversion price in the exchange quoted currency is equal to or better than the price for the financial instrument available on the exchange in the exchange quoted currency, automatically submitting a FX conversion order to the FX trading platform for a pre-match order for which matching at the FX trading platform is performed up to the point before sending confirmation of the limit order;
receiving acknowledgment of validation of the pre-match order from FX trading platform at the multicurrency interface;
submitting a limit order in the exchange quoted currency to the exchange; and
when execution of the limit order on the exchange is confirmed, automatically submitting a message electronically from the multi-currency interface to finish execution of the conversion order in the FX trading platform.

3. The method of claim 1, wherein orders on the FX trading platform are required to be honored for a predetermined execution time after a new price or a price cancellation is submitted to the FX trading platform.

4. The computerized method of claim 1, wherein the order from the at least one customer is received from a member of the trading exchange, on behalf of the customer.

5. The computerized method of claim 1 wherein the member of the trading exchange also has an account with the FX trading platform.

6. A multi-currency interface for facilitating trading of financial instruments in multiple currencies comprising:
one or more server computers executing on one or more processors, the multi-currency interface in communication with (a) a computerized trading exchange system that trades securities denominated in an exchange quoted currency and (b) a foreign exchange (“FX”) trading platform, the multi-currency configured and programmed to:
receive a limit order from at least one customer for a financial instrument, including a price and a quantity denominated in a customer currency, at a multi-currency interface comprising one or more server computers executing on one or more processors in communication with (a) a computerized trading exchange system that trades the financial instrument denominated in an exchange quoted currency and (b) a foreign exchange (“FX”) trading platform;
electronically monitor available liquidity on the computerized trading exchange and the FX trading platform at the multi-currency interface;
when a new price is published on the computerized trading exchange in the exchange quoted currency for the financial instrument, automatically request available prices on the FX trading platform;
receive the available prices on the FX trading platform at the multicurrency interface;
calculating at the multi-currency interface a price in the exchange quoted currency for converting the limit order in the customer currency to the exchange quoted currency based upon real time spot tradable index prices published by the FX trading platform;
determine whether the conversion price is still available on the FX trading platform; and
convert the limit order in the customer currency to the exchange quoted currency based on real time spot tradable index prices published by the FX trading platform.

7. The multi-currency interface of claim 6, wherein orders on the FX trading platform are required to be honored for a predetermined execution time after a new price or a price cancellation is submitted to the FX trading platform.

8. The multi-currency interface of claim 6, wherein the order from the at least one customer is received from a member of the trading exchange, on behalf of the customer.

9. The multi-currency interface of claim 6 wherein the member of the trading exchange also has an account with the FX trading platform.

10. A computerized method for facilitating transactions of goods and services in multiple currencies, the method comprising:
determining, by a multi-currency interface comprising one or more server computers executing on one or more processors in communication with (a) a computerized online merchant system that offers goods and services denominated in an online merchant system currency and (b) a foreign exchange (“FX”) trading platform, to present to at least one customer wishing to purchase the goods or services in a customer currency, a view of goods or services offered for sale currently residing on the online merchant system, the view being presented in the customer currency;
receiving, at the multi-currency interface, an order for the goods or services offered for sale on the computerized online merchant system, including at least a price and a quantity, from the at least one customer, the received order being denominated in the customer currency;
if the customer currency is the same as the online merchant system currency, submitting the order to the online merchant system for execution; and
if the customer currency is not the same as the online merchant quoted currency, executing the following steps:
performing, at the multi-currency interface, a calculation of a conversion rate of the price of the received order from the customer currency to the exchange traded quoted currency, the calculation being performed based upon real time spot tradable FX index prices published by the FX trading platform;
generating an FX spot trade order on the FX trading platform at the conversion rate to generating, at the multi-currency interface, an order for the goods or services, denominated in the online merchant system quoted currency, corresponding to the received order from the customer; and
submitting the generated goods or services order to the online merchant system for purchase of the goods or services in the customer currency.

11. The computerized method of claim 10, wherein the customer can select one or more customer currencies.

12. The computerized method of claim 10, wherein the presenting step comprises performing the following steps:
(a) determining whether the customer currency is the same as the online merchant quoted currency, and if so, displaying the order to the customer without conversion;
(b) if the customer currency is different from the online merchant quoted currency, converting the order to the customer currency for display to the customer by:
(i) performing, at the multi-currency interface, a calculation of a conversion rate of the goods and services from the exchange traded quoted currency to the customer currency, the calculation being performed based upon FX index prices published by the FX trading platform, and
(ii) generating an FX spot trade on the FX trading platform at the conversion rate to generate an order in the customer currency that corresponds with the order of the goods or services from the online merchant system; and
(c) displaying the generated order to the customer in the customer currency.

13. The computerized method of claim 10, wherein the generating presenting step comprises:
determining if a currency pair of the online merchant system quoted currency and the customer currency is a pair quoted directly on the FX trading platform,
generating spot trade orders to buy at the conversion rate on the FX trading platform, the online merchant system quoted currency versus the customer currency in a transaction that is long in the online merchant system quoted currency and short in the customer currency; and
if the currency pair of the exchange quoted currency and the customer currency pair is not a pair quoted directly on the FX trading platform,
creating a synthetic price by generating FX trade orders to buy the exchange quoted currency against a major currency quoted directly on the FX trading platform, and selling the customer currency against the same major currency at real time spot tradable FX index prices published by the FX trading platform to generate the goods or services order.

14. The computerized method of claim 10, wherein the at least one customer comprises a plurality of buyers, each having a buyer's currency, and sellers, each having a seller's currency, and, after a match between orders of a respective buyer and seller on the online merchant system results in a purchase transaction between the buyer and the seller, the method further comprises:
the multi-currency processor:
receiving orders from the buyer and the seller; and
determining at the multi-currency interface what FX transactions are needed to facilitate the multi-currency transaction and clearing process, and executing submitting, on behalf of the buyer and the seller, FX spot trades orders based on the determination, wherein the FX spot trade orders are matched internally on the FX trading platform to match buyers and sellers of the goods or services on the online merchant system without using any other liquidity sources whenever possible or otherwise matched against other liquidity on the FX trading platform.

15. The computerized method of claim 10, wherein the order from the at least one customer is received from a member of the online merchant system.

16. The computerized method of claim 10, wherein the at least one customer comprises a buyer and a seller and the buyer and the seller communicate electronically with the multi-currency interface using a buyer client terminal and a seller client terminal, respectively.

17. A multi-currency interface for facilitating trading of goods and services in multiple currencies comprising:
one or more server computers executing on one or more processors, the multi-currency interface in communication with (a) an online merchant system that trades goods and services denominated in an online merchant system quoted currency and (b) a foreign exchange (“FX”) trading platform, the multi-currency interface being in communication with both the FX trading platform, the multi-currency interface having one or more server computers configured and programmed to:
present, to at least one customer wishing to trade in a customer currency, a view of goods or services currently available for purchase on the online merchant system, the view being presented in the customer currency;
receive an order for the goods or services, including at least a price, from the at least one customer, the received order being denominated in the customer currency;
if the customer currency is the same as the online merchant quoted currency, submit the order to the trading exchange for publication on the trading exchange; and
if the customer currency is not the same as the online merchant quoted currency, execute the following steps:
perform a calculation of a conversion rate of the price of the received securities order from the customer currency to the online merchant quoted currency, the calculation being performed based upon real time spot tradable FX index prices published by the FX trading platform,
generate an FX spot trade order on the FX trading platform at the conversion rate to generate an order in the customer currency that corresponds with the received order;
generate an order for the goods or services, denominated in the online merchant quoted currency, corresponding the to the received order from the customer; and
submit the generated goods or services order to the online merchant system for purchasing the goods or services.

18. The multi-currency interface of claim 17 configured and programmed to enable the customer to select one or more customer currencies.

19. The multi-currency interface of claim 17 configured and programmed to present to at least one customer wishing to trade in the customer currency, the view of orders currently residing on the trading exchange, the server computers of the multi-currency interface further configured and programmed to:
for each order on the online merchant system, perform the following steps:
(a) determining whether the customer currency is the same as the online merchant quoted currency, and if so, displaying the goods or services order to the customer without conversion;
(b) if the customer currency is different from the online merchant quoted currency, converting the order to the customer currency for display to the customer by:
(i) performing, at the multi-currency interface, a calculation of a conversion rate for the goods or services order from the online merchant quoted currency to the customer currency, the calculation being performed based upon real time spot tradable FX index prices published by the FX trading platform, and
(ii) generating executing an FX spot trade order on the FX trading platform at the conversion rate to generate an order for the goods or services in the customer currency that corresponds with the goods or services order; and
(c) displaying the generated order to the customer in the customer currency.

20. The multi-currency interface of claim 17 configured and programmed to:
if a currency pair of the exchange quoted currency and the customer currency pair is a pair quoted directly on the FX trading platform,
use the calculated conversion price generating FX spot trade orders to buy at the conversion rate to buy, on the FX trading platform, the online merchant quoted currency versus the customer currency in a transaction that is long in the exchange quoted currency and short in the customer currency, and generate the goods or services order; and
if the currency pair of the exchange quoted currency and the customer currency pair is not a pair quoted directly on the FX trading platform,
create a synthetic price by generating FX trade orders to buying the exchange quoted currency against a major currency quoted directly on the FX trading platform, and selling customer currency against the same major currency to generate the online merchant system goods or services order.

21. The multi-currency interface of claim 17, wherein the at least one customer comprises a plurality of buyers, each having a buyer's currency, and sellers, each having a seller's currency, and, after a match between orders of a respective buyer and seller on the exchange results in a trade between the buyer and the seller,
the multi-currency processor configured to:
receiving trade confirmations to the buyer and the seller; and
determine what FX transactions are needed to facilitate the multi-currency transaction and clearing process, and submits, on behalf of the buyer and the seller, FX spot trades based on the determination.

22. The multi-currency interface of claim 17, wherein the conversion rate is a midpoint price for a currency pair the customer currency and online merchant currency.

23. The multi-currency interface of claim 23, wherein the online merchant system is configured and programmed to search similar products offered for sale in the customer currency to find the best price for the customer.
